(19) United States
(12) Patent Application Publication
(10) Pub. No.: US 2001/0044801 A1
(43) Pub. Date: Nov. 22, 2001

(54) Process for producing an electronic color information data file and process for color communication

(76) Inventors: Thomas Senn, Dielsdorf (CH); Thorsten Braun, Rheine (DE); Simon Greter, Zurich (CH); Francis Lamy, Mamaronck, NY (US)

Correspondence Address: Patrick C. Keane, Burns, Doane, Swecker & Mathis, L.L.P., P.O. Box 1404, Alexandria, VA, 22313-1404, US

(21) Appl. No.: 09/835,465

(22) Filed: Apr. 17, 2001

(30) Foreign Application Priority Data
Apr. 18, 2000 (EP) 00 107 983.9

(51) Int. Cl. G06F 17/30

(52) U.S. Cl. 707/104.1; 345/589

(57) ABSTRACT

A color information file is produced in a processor for the communication of colors, which file can include all possible information data assigned to one or several color samples and identifying, characterizing or supplementing them. The information data are stored as data objects in the data information file in an open and expandable hierarchically organized object structure on XML basis in text format. By embedding the data objects in an XML container, it is possible to characterize color samples by way of arbitrary and different combination of information data and to selectively add complementary image or text information. The color information file is produced with the help of a text editor or a composer software, for example with graphic user interface. A viewer software is provided for the reading of the color information file and for interpretation of the information data stored therein.

### FIELD OF THE INVENTION

The invention relates to a process for producing an electronic color information data file which is intended and suited for color communication and which includes a data set describing the color impression of one or more color samples, whereby the data set is made available in a processor and stored in a preselected data format in the color information file.

The invention also relates to a process for the communication of information relevant for the visual color impression of a color sample set including at least one color sample, whereby the information represented by measured data and/or manually produced value data is stored at a transmitter end in a color information file, the color information file is transferred to a receiver by way of a communication medium and then at the receiver end again displayed in visual form.

### BACKGROUND OF THE INVENTION

Standardized color communication has been a subject for years. Color communication today is carried out typically by way of measured parameters of the colors. These are on the one hand classic calorimetric measured parameters of the colors to be transmitted such as CIE-Lab-, XYZ-, RGB-, density-, CMYK-values and spectral measured values on the other.

An essential aspect of color communication lies in the differentiation whether apparatus dependent or apparatus independent color spaces are used. If apparatus independent color spaces are used, the color profiles assigned to the pictures or input and output apparatus still allow a precise color communication. The corresponding mechanisms were defined, for example by the ICC (international color consortium). The apparatus specific color spaces are thereby specified by so-called apparatus profiles. The generation of such an apparatus profile can be read up on, for example, in the ICC specification “Spec ICC.1: 1998-09”.

The use of these measured parameters for transmitting the measured data of individual colors (spot colors) or of color tables or atlases is described in detail, for example, in the ANSI standard IT8.7/2-1993 (graphic technology-color reflection target for input scanner calibration). Especially one possibility is illustrated therein of how different colorimetric or spectral measured data from individual color fields can be packaged into a file format.

Other approaches for color communication are color spaces or “named color spaces”. Typical representatives thereof are, for example, Pantone, RAL, NCS, Toyo or HKS color spaces. Fixed definitions are thereby assigned to colors defined by color samples or measured values. These definitions are then correspondingly transmitted.

Human color perception, however, is not only influenced by the measured values of the color itself, but also by influences of the surrounding fields, for example, the absolute brightness of the color, the neighboring colors, and so on. In the CIE publication CIE 131-1998 (The CIE 1997 interim color appearance model (simple version) CIECAM 97s) and other publications, mathematical models of how some of these effects can be mathematically modeled are defined.

Other effects which influence the color perception are surface effects such as, for example, shine effects, which are defined, for example, by the surface structure of the color or the substrate. These effects are typically measured by shine measuring apparatus according to standard DIN 16537.

Furthermore, direction dependent admission or remission effects as present, for example, in metallic paints, are known. These effects are typically measured by an angle dependent color measurement with a Gonio spectrophotometer. A color definition must then be defined by several measured values which represent this angle dependency.

A further important aspect of the color measurement is the substrate on which the color is applied. For example, depending on the selected substrate, fluorescence effects can occur. These fluorescence effects are typically caused by the use of optical brighteners. In order to make a statement which optical visual effects will occur under which physical light sources, details on the substrate must be available. These can be, for example, classical measured values such as whiteness and yellowness grades. However, a measurement from a double monochromator spectrophotometer can also be available with the help of which the substrate can be measured in the wavelength range of 360 nm to 270 nm. Such fluorescence effects can also be present in the color respectively used. These effects can be quantified as well with the help of a suitable measurement, for example the measurement with a double monochromator spectrophotometer.

A further essential effect for the perception is the homogeneity and structure of the color original. This homogeneity could, for example, be shown by one or more representations (possibly recorded from different angles).

Important for an assessment of colors is furthermore the shape, size and location of the color fields relative to one another. Shape and location of the colors influence, for example, the simultaneous contrast of the color fields.

A further aspect of the color communication is the incorporation of color tolerances. Color tolerances can be defined in different ways. In the software application “ColorQuality” of the Company Gretag-Macbeth it is shown how tolerances can be assigned to color samples, for example, in the CIE-Lab, CMC, FMCII or other color spaces. Such color tolerances in corresponding color spaces must be assigned to color samples and must be correspondingly transmitted during the color communication.

A further important aspect of color communication is the incorporation of the physical measurement conditions. For example, the following optical arrangements are known for the capturing of spectral and other calorimetric measurement data: 45/0 degree geometry with or without a polarizor and selectively equipped with a D65-or A- light illumination; spherical geometry diffuse/8 degrees with or without shine trap; Gonio spectrophotometer with several pickup or illumination angles. Different measurement values are obtained for different types of the optical arrangements. These measurement values can only be converted into measurement values of other physical arrangements by limitation of the universality. It is therefore absolutely necessary to also communicate the corresponding physical measurement conditions. One example of how it is principally possible to transfer these measurement conditions is illustrated, for example, in the software application “color quality” of the company Gretag-Macbeth. The measurement conditions can thereby be different from measuring probe to measuring probe.

An essential aspect of the color communication is also the incorporation of the illumination light types. The CIE has for example standardized different illumination light types for the purpose of color definition (for example D65, D50, A, C, F1. . . F11). Depending on the type of the illumination light source, remission color samples are differently assessed. For this reason, most color measuring apparatus and color measuring software packages identify the corresponding illumination light types which were used in the calculation of calorimetric measurement parameters. It can further be desired that colors are not only assessed under the known illumination light types, but that any, for example, technically measurable illumination light types are used for the color assessment. A universal color exchange format must therefore not only be able to communicate remission originals, but also light sources and other emission standards and must be able to place those sources in relation to the corresponding remission originals.

In order to correctly describe, analyze and communicate a color, several aspects of the color must be defined. It is not sufficient to simply provide a calorimetric value, for example a spectrum of the color. Especially the above described remaining aspects relevant for the color assessment, which are combined in the following under the term “appearance” are given no consideration in the conventional color communication processes.

Depending of the respective application, different aspects/attributes (measurement values, descriptions) are important during color communication for a correct color specification. A data exchange format for colors must take this into consideration.

The data exchange formats known to date, for example the IT8 format, are based essentially on a tabular representation of measurement values (for example, spectra or calorimetric values). For each color sample, for example, the description, one or more calorimetric measurement values or spectra, etc., are thereby listed in tabular form. This type of storage or transmission runs into limitations as soon as not the same type of measurement values or further associated attributes such as, for example, color recipes, images, and so on, are used for each color probe. When using the classical approach of tables for the storage of these objects, the corresponding table would thereby need to be expanded by one or more columns for each newly added attribute. This would lead to large and complex tables. Many data fields in such a table would then not be occupied and would represent an unnecessary load for the processing computer.

### SUMMARY OF THE INVENTION

It is the goal of the invention to provide a process for electronically communicating the color data and the parameters associated therewith or storing them in a manner suited for data exchange. Transmission should thereby be possible of not only colorimetric data but of all other attributes of the color or color sample necessary for the assessment (appearance) and exact identification and information of the color. Furthermore, colors should thereby also be specified in different ways and those specifications made available to all possible software applications so that the user can select which aspect of the color definition he wants to use in his application.

Generally, it is conceivable that depending on the application not only parameters necessary for the color or the appearance must be stored or communicated for each color, but that also other information such as, for example, color recipes, area of coverage for the screening of colors, prices, weights or any other further information, which can be of use in any application, must be stored and transmitted together with the actual color data in a narrow sense. The process in accordance with the invention is also intended to deal with this situation.

In general, the attributes which may eventually be desired in any application cannot be set from the beginning once and for all by definition of the color exchange format. The process in accordance with the invention must therefore be universally applicable and open, for example, expandable, so that new attributes can be added to the data exchange format for newly added applications or the data exchange format correspondingly expanded. The these new additional attributes thereby must not influence the applicability of the already know attributes in other applications (backward compatibility).

It is also important for the communication of color data and the associated values that the data exchange format used therefor is not tied to a specific software manufacturer, but can be expanded to alternate manufacturers of software. The known information should thereby still remain interpretable by the original applications, while the newly added information is of course supported only by the new, alternate manufacturer specific application.

The process in accordance with the invention for the production of a color information data file and the process in accordance with the invention for color communication, which handle these complex problems, are defined in the independent claims 1 and 21. Especially advantageous embodiments and further developments are the subject of the respectively dependent claims.

### BRIEF DESCRIPTION OF THE DRAWINGS

The invention will be further described in the following with reference to a preferred embodiment and in connection with the drawing, wherein

FIG. 1 shows the principle schematic drawing of the process in accordance with invention for producing a color information data file;

FIG. 2 shows a graphic representation of a data exchange format as used in the process in accordance with the invention; and

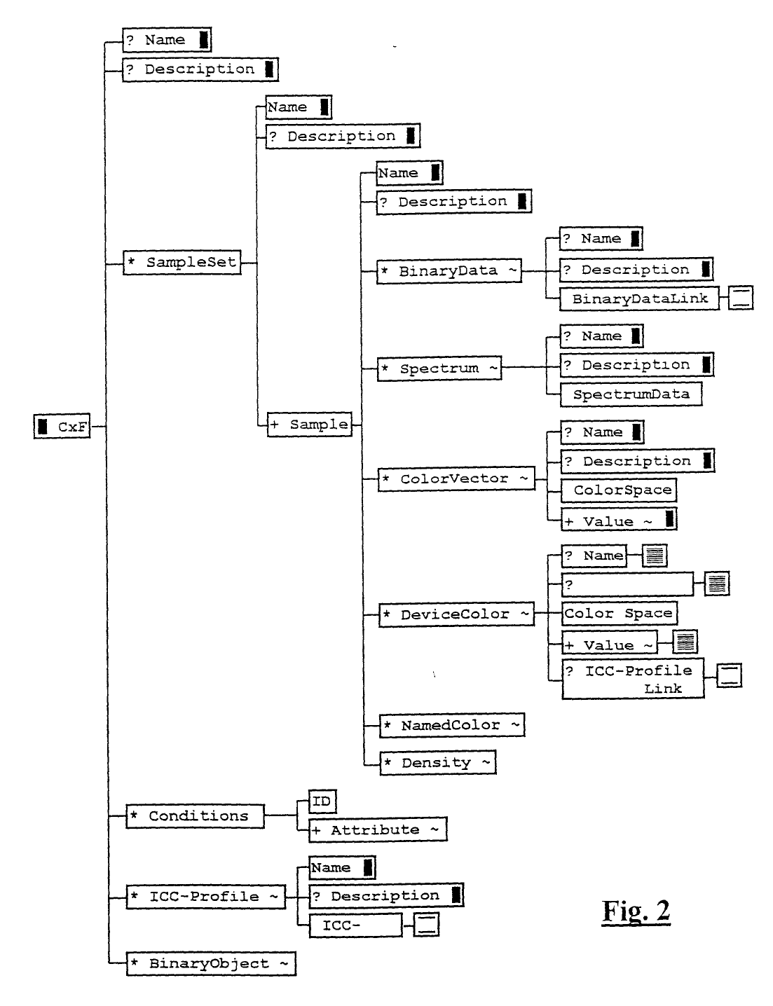

FIG. 3 shows a principle schematic diagram of the color communication process in accordance with invention.

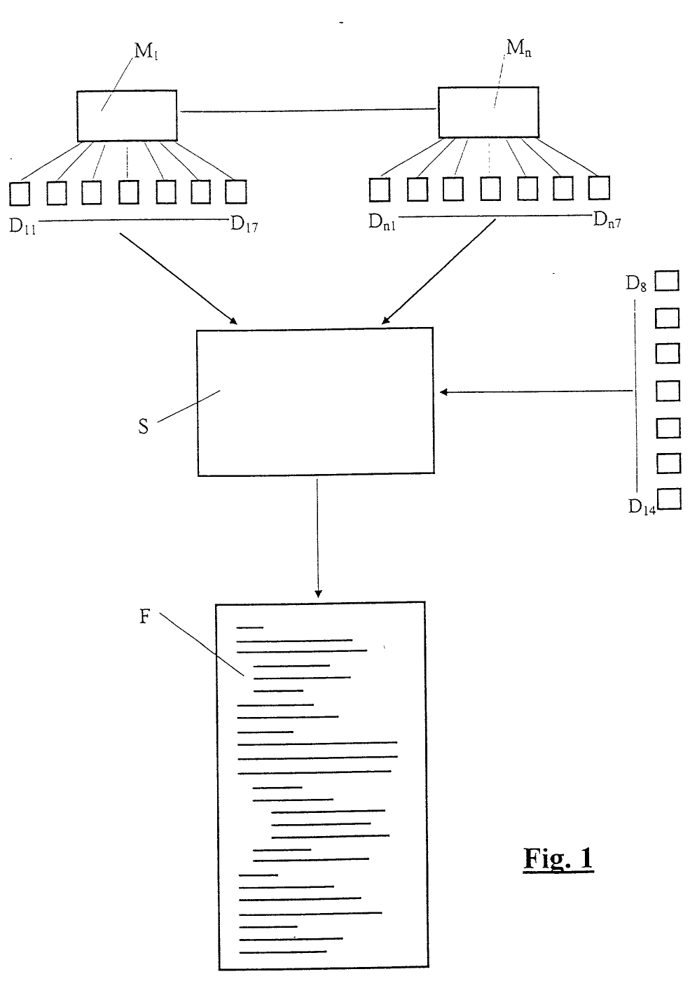

As discussed above, the color impression of a color sample can be described by a number of properties (attributes) and represented by corresponding information data. These properties include especially spectral or calorimetric measurement values as well as different values or parameters, etc., relevant for the so-called appearance. An exemplary color sample set is shown in FIG. 1 which is made of a number of color samples M₁-Mₙ, whereby the information data characterizing the color samples is symbolically represented by boxes D₁₁-D₁₇ . . . Dₙ₁-Dₙ₇. Complementary information data, for example, measurement conditions, exposure light type, substrate properties, ICC profile or other interesting data and information, are symbolically represented by boxes D₈-D₁₄. More details can be derived from the introduction and the following description.

The total information data pertaining to the color samples and identifying and characterizing or complementing them is made available in a processor and therein processed into a color information file F by way of a supporting software SS. The term “made available” means that the information data are produced by measuring of the actual color sample or by manual input in text format or by way of graphic user interfaces, and are made available in the processor as corresponding data.

According to the basic aspect of the invention, the information data are thereby stored as data objects including the information data and in open and expandable hierarchy to the organized object structure in the color information data file F. Each data object is provided with a characterizing tag (type description) from a predefined group of type descriptions (tags), or by the type description provides information on the structure and content of the data object. The type description (tag) of the data object is stored in defined relationship to the information data of the data object in the color information data file. The data objects themselves can again include one or more hierarchically subordinate data objects, whereby each subordinate data object is also labeled with a characterizing type description (tag) selected from a predefined group of type descriptions (tags). The data objects of the uppermost level of hierarchy and/or the data objects respectively subordinate to a data object are assigned a name designating the respective data objects and an explanatory description which are stored in defined relation to the respective data objects in the color information file. Individual data objects can also represent a hyperlinks to another data object within or outside the color information file. All the objects are stored in text form in the color information file. Data objects can also include a binary data object as information data, whereby this binary data object is preferably stored in the color information file and in MIME-compatible form coded in text characters.

The hierarchically organized object structure of the data objects is formed on the basis of a page description language, especially the Extensible Markup Language (XML). This allows a universal, largely platform independent and language independent data exchange format. Details to XML are extensively documented in, for example, the Addison Wesley publication “XML in the practice; professional Web publishing with the extensible markup language”.

The storage of the information data pertaining to the color samples and identifying, characterizing or complementing them can be carried out by way of arbitrary selection from a predefined group of data object types, whereby this group of data object types can be expanded anytime by additional data object types. The type and structure of the information data contained is set for each data object type. Typically, data objects for spectral data and calorimetric data (color vectors) and apparatus dependent color data, data objects for further information data relevant for the visual color impression, data objects for ICC profiles, measurement conditions, light source data and apparatus profiles, data objects for image data and/or data describing a substrate are present as are data objects for complementary data representable in text form. By using these predefined data object types, for example, any desired combination of emission, remission and transmission spectra and/or colorimetric data (color vectors) can be stored in the color information file for each color sample, whereby the data object types used for the individual color samples of a color sample set can also be different.

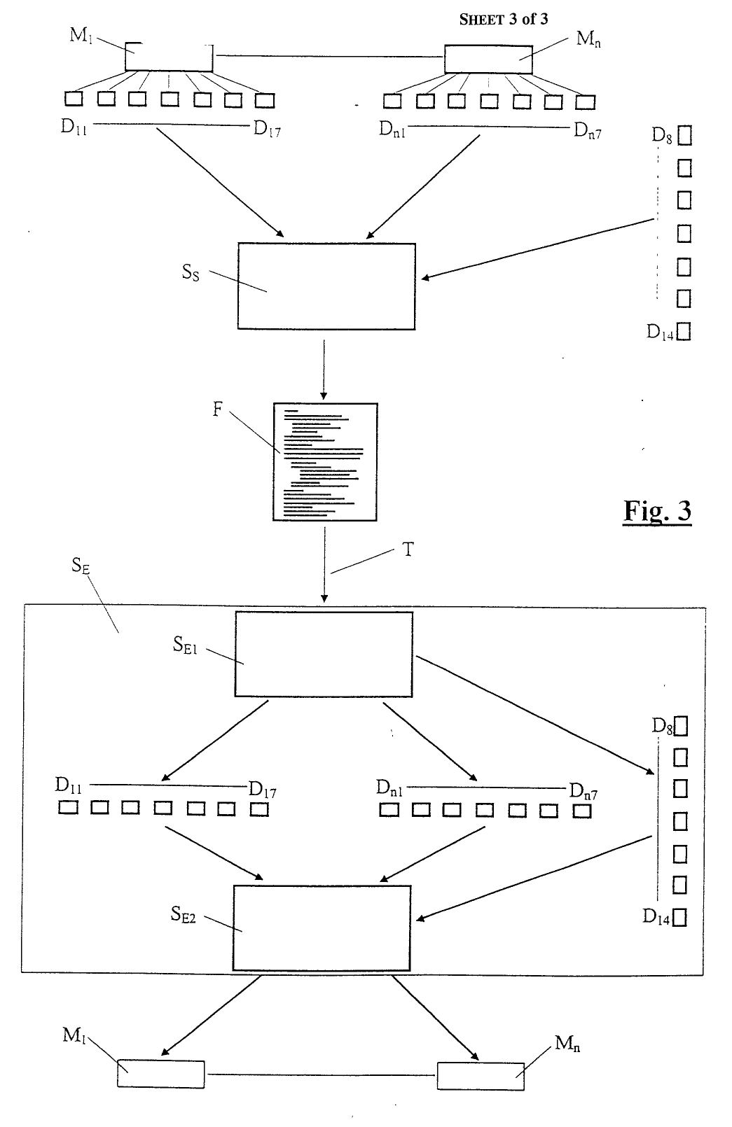

FIG. 3 schematically illustrates the principle steps of the color communication process in accordance with invention.

A color information file F is built at the transmitter end in the above described manner from the information data D₁₁-D₁₇ . . . Dₙ₁-Dₙ₇ and the complementary information data D₈-D₁₄ characterizing the color samples M₁-Mₙ to be transmitted. This color information file F is then transmitted by way of a suitable transport medium T for example via Internet or by use of a conventional data carrier, to the receiver end and there transferred to a receiver end software S_{E}. The latter includes essentially two main components S_{E1} and S_{E2}. The first main component S_{E1} reads out the color information file F and reconstructs therefrom the original information data D₁₁-D₁₇ . . . Dₙ₁-Dₙ₇ and the complementary information data D₈-D₁₄ characterizing the color samples M₁-Mₙ to be transmitted. The second main component interprets the information data and produces there from a visual representation of the underlying color samples M₁-Mₙ. The visual representation of the color samples can, for example, the carried out on a screen or output on a printer. The receiver end software SE can also include further components, which allows a recalculation or other manipulation of information data and a corresponding visualization of the manipulated data. This is described in detail further below.

In detail, the process for the producing of a color information file or for the color communication typically proceeds in the following manner. A color sample or the measurement values describing its colors are captured by a user with a spectrophotometer or another device suited for the color measurement. Alternatively, the user can define the color in text form or in a device dependent color space (“device color space”, for example, CMYK or RGB) (text input or input over graphic user interface). If the user captures the color with the help of a measurement device, the measurement data are queried (for example via ethernet, USB or RS 232) from the measurement device by a software belonging to the measurement device used or by a suitable data exchange protocol (for example the SPM protocol of the company Gretag-Macbeth). If the user defines the color in device dependent form, he will often associate the color also with a device profile in order to allow the system to later recalculate the device dependent color as a device independent color. The user can then selectively adds further information to this color sample. Typical information is for example images, further physical details on the color medium producing the respective color (for example printer ink) such as weight, density, amounts, or commercial details such as prices and so on. The software S therefor provides a corresponding user interface. The software in the next step typically produces a visualization of the color on the output device. For the color representation, the software typically uses known algorithms/processes as used in color management systems for the color visualization. Such functions are integrated in many operating systems (for example the software package “ColorSync” in Apple Macintosh processors).

According to the main aspect of the present invention, the data are then serialized in the manner sketched in principle above in a language derived from the XML language definition and in the following designated C×F. Details will be discussed further below. The serialized data can then be selectively stored in a file or embedded into another data object defined by a third party manufacturer (for example a text file).

Since the data serialized in this matter are present in the form of a pure (for example ASCII) text file, the latter can principally be manually produced by way of any text editor. However, a suitable software Sₛ is used therefor which preferably provides a graphic user interface by which the desired data can be comfortably read into the C×F file. Such a software works principally like conventional HTML editors and therefore need not be further described to the person skilled the art. This software S which is used for the construction of a C×F file or a corresponding C×F object is referred to in the following as “C×F composer”.

The following example 1 shows how, for example, 3 color samples from the commonly known sample set “Pantone” with names “Yellow C”, “Warm Red” and “Process Yellow C” are stored in the form of a color information file. For the first color, essentially the lab values with reference to the corresponding measurement conditions, a reference to a “named color” (Pantone name of the color) with reference to the measurement conditions, and the spectral measurement values with reference to the measurement conditions are stored. For the second color, a “spectrum” of 36 spectral measurement values as well as a reference to the corresponding measurement conditions is stored. For the third sample, a spectrum, an XYZ value, an RGB value with associated ICC profiles are entered into or stored in the file. Subsequent to the description of the samples, the measurement conditions and the above referenced ICC device profile are stored. The aspect that in the selected data storage format any desired information, which means information independent from other color samples, can be stored for each color sample deserves special consideration. As is apparent from the following example, each data object to be stored is introduced, as in other languages derived from XML, by a so-called “tag” of the format “<tag name>”, whereby “tag name” is representative for the actual name of the respective tag. This is followed by a data block. At the end, the object is terminated by “</tag name>”.

The data block itself can then again include any number of interlocking subobjects which are encoded in recursive manner into the file. In order to save storage space and to increase universality, links to other locations in the file can be alternatively added at the locations in the file where always the same object would have to be embedded. This generally known technique is here used, for example, for the storage of the physical measurement conditions of the color samples (“UniqueID1”).

### EXAMPLE 1

<?xml version=“1.0” encoding=“UTF-8”?>
<!DOCTYPE CXF SYSTEM “file:/G:/ColorLab/ColorLab/CXF/cxf.dtd”>
<CXF>
<Name>PANTONE</Name>
<Description>Color Formula Guide 1000</Description>
<SampleSet>
<Name>Basic Colors</Name>
<Description>Basic Colors of this swatchbook</Description>
<Sample>
<Name>Yellow C</Name>
<ColorVector Conditions=“UniqueID1”>
<ColorSpace>CIE-Lab</ColorSpace>
<Value Name=“L*”>89.62</Value>
<Value Name=“a*”>-9.35</Value>
<Value Name=“b*”>110.77</Value>
</ColorVector>
<NamedColor Conditions=“UniqueID2”>PANTONE Yellow
C</NamedColor>
<Spectrum Conditions=“UniqueID1”>
<SpectrumData>0.0333 0.0303 0.0268 0.0238 0.0223 0.0210 0.0204
0.0207 0.0219 0.0235 0.0289 0.0563 0.1814 0.4662 0.7146 0.8075 0.8385
0.8509 0.8585 0.8663 0.8707 0.8740 0.8762 0.8790 0.8822 0.8834 0.8865
0.8902 0.8923) 0.8906 0.8920 0.8931 0.8947 0.8955 0.8937
0.8929</SpectrumData>
</Spectrum>
<BinaryData UniqueID=“Pic1”/>
</Sample>
<Sample>
<Name>Warm Red C</Name>
<Spectrum Conditions=“UniqueID1”>0.0810 0.0748 0.0689 0.0713
0.0749 0.0740 0.0712 0.0622 0.0486 0.0375 0.0309 0.0269 0.0254 0.0258
0.0269 0.0279 0.0304 0.0371 0.0611 0.1522 0.3522 0.5776 0.7340 0.8111
0.8452 0.8598 0.8690 0.8767 0.8810 0.8811 0.8828 0.8846 0.8874 0.8892
0.8880 0.8879</Spectrum>
</Sample>
<Sample>
<Name>Process Yellow C</Name>
<ColorVector Conditions=“UniqueID3”>
<ColorSpace>XYZ</ColorSpace>
<Value Name=“X”>20</Value>
<Value Name=“Y”>20</Value>
<Value Name=“Z”>30</Value>
</ColorVector>
<DeviceColor Conditions=“UniqueID4”>
<ColorSpace>RGB</ColorSpace>
<Value Name=“R”>55</Value>
<Value Name=“G”>88</Value>
<Value Name=“B”>145</Value>
<ICC-ProfileLink UniqueID=“A Profile1”/>
</DeviceColor>
</Sample>
</SampleSet>
<BinaryObject Name=“Pic1” MIME-Type=“TIFF”>Binary data in
the MIME format goes here. </BinaryObject>
<ICC-Profile Name=“A Profile I”>
<ICC-Data>Store the ICC-File MIME-encoded here. </ICC-Data>
</ICC-Profile>
<Conditions>
<ID>UniqueID1</ID>
<Attribute Name=“Filter”>No</Attribute>
<Attribute Name=“Geometry”>45/0</Attribute>
<Attribute Name=“Illumination”>D65</Attribute>
<Attribute Name=“LambdaMin”>360</Attribute>
<Attribute Name=“LambdaMax”>720</Attribute>
<Attribute Name=“NrOfDataPoints”>36</Attribute>
</Conditions>
<Conditions>
<ID>UniqueID2<ID)>
<Attribute Name=“Filter”>D65</Attribute>
<Attribute Name=“Illumination”>2°</Attribute>
<Attribute Name=“LambdaMin”>360</Attribute>
<Attribute Name=“LambdaMax”>750</Attribute>
<Attribute Name=“NrOfDataPoints”>40</Attribute>
</Conditions>
<Conditions>
<ID>UniqueID3</ID>
<Attribute Name=“Geometry”>45/0</Attribute>
</Conditions>
<Conditions>
<ID>UniqueID4</ID>
<Attribute Name=“RGB-Rang”>0-255</Attribute>
</Conditions>
</CXF>

The objects embedded into the file format (for example ICC profile, images) are thereby re-coded into a text representation. For example a MIME compatible data format can be used for such objects.

This description of the objects and attributes contained in an XML coded file is most easily carried out with a generally known document type definition file (DTD). An example of a graphical representation of an exemplary version of the DTD for the color exchange format C×F used in the process in accordance with the invention as illustrated in FIG. 1. A C×F file or a C×F object would be syntactically described in DCD in text form as follows: <!—Color eXchange Format—>

<!ELEMENT CXF (Name,Description?,SampleSet*,Conditions*,
ICC-Profile*,BinaryObject*)>
<!ELEMENT Name (#PCDATA)>
<!ELEMENT Description (#PCDATA)>
<!ELEMENT SampleSet (Name,Description?,Sample+)>
<!ELEMENT Conditions (ID,Attribute+)>
<!ELEMENT ICC-Profile (Name,Description?,ICC-Data)>
<!ATTLIST ICC-Profile Name CDATA #IMPLIED>
<!ELEMENT BinaryObject (#PCDATA)>
<!ATTLIST BinaryObject Name CDATA #IMPLIED MIME-Type
CDATA #IMPLIED>
<!ELEMENT SampleName (Description?,BinaryData*,Spectrum*,
ColorVector*,DeviceColor*,NamedColor*,Density*)>
<!ELEMENT ID (#PCDATA)>
<!ELEMENT Attribute (#PCDATA)>
<!ATTLIST Attribute Name CDATA #IMPLIED>
<!ELEMENT ICC-Data EMPTY>
<!ELEMENT BinaryData (Name?,Description?,BinaryDataLink)>
<!ATTLIST BinaryData UniqueID CDATA #IMPLIED>
<!ELEMENT Spectrum(Name?,Description?,SpectrumData)>
<!ATTLIST Spectrum Conditions CDATA #IMPLIED>
<!ELEMENT ColorVector (Name?,Description?,ColorSpace,Value+)>
<!ATTLIST ColorVector Conditions CDATA #IMPLIED>
<!ELEMENT DeviceColor (Name?,Description?,ColorSpace,Value+,
ICC-Profile Link?)>
<!ATTLIST DeviceColor Conditions CDATA #IMPLIED>
<!ELEMENT NamedColor (Name,Description?)>
<!ATTLIST NamedColor Conditions CDATA #IMPLIED>
<!ELEMENT Density (Name?,Description?,DensityData+)>
<!ATTLIST Density Conditions CDATA #IMPLIED>
<!ELEMENT BinaryDataLink EMPTY>
<!ELEMENT SpectrumData (#PCDATA)>
<!ELEMENT ColorSpace (#PCDATA)>
<!ELEMENT Value (#PCDATA)>
<!ATTLIST Value Name CDATA #IMPLIED>
<!ELEMENT ICC-ProfileLink EMPTY>
<!ATTLIST ICC-ProfileLink UniqueID CDATA #IMPLIED>
<!ELEMENT DensityData (#PCDATA)>
<!ATTLIST DensityData Filter CDATA #IMPLIED>

It is thereby always possible to complement the file format by further desired new attributes. For that, only corresponding new tags need to be defined and added to the file. This complementing can thereby be carried out by that user (producer of user software) who needs to store additional information to the data object because of its own needs. Because of the selected data storage structure, none of the applications which go back to the previous data exchange format are affected. This means that when the application cannot interpret a specific attribute of a color, the application simply jumps over the attribute. Should it be advantageous for an application, for example, to define the substrate corresponding to the color sample, the elements “sample” can simply be replaced by an expanded definition which includes the data or a reference to the data of the substrate.

The storage itself is carried out through a software package (software library, referred to in the following as C×F SDK). The software library thereby consists essentially of four layers. The lowest layer (“C×F file”) represents the actual file format. Layer two includes the functionality to read data sets or C×F objects embedded in other data sets into the main memory of a computer. A tree structure is thereby built which corresponds to the data file structure. One can refer back to attributes of this tree structure. The third layer (“C×F calorimetric data”) allows for interpretation of these attributes as colorimetric values. The uppermost, fourth layer (“C×F appearance data”) allows for the possibility to recalculate the calorimetric values obtained in the third layer according to a selected appearance model and to display, for example, on a screen the derived RGB data. The layer structure of the software library is illustrated in the following table.

CxF - appearance data
C++ Software Development Kit (SDK)
Accessed to “appearance” information
CxF - colorimetric data
C++ Software Development Kit (SDK)
High-level C++ access to the colorimetric data
CxF - data structure
C++ Software Development Kit (SDK)
Low-level C++ access to the data structure
CxF - File
Data file format: XML

It is a special property of the uppermost, fourth layer that the layer can be made of several independent modules whereby each module covers one application area. This is illustrated in the following table. The first module offers for example color management functionality for the higher application programs, for example the color management software “LTT” of the company Logo. A second module can be a color recipe software and can provide, for example, appearance transformations of color values for the metallic paint area. A further module can stimulate textures, and so on.

| | | | |
|---|---|---|---|
| CMM | Color recipe | Texture Simulation | Further Software |
| LTT of logo | (InkForm Engine) | software | |
| Layer 3 | | | |
| Layer 2 | | | |
| Layer 1 | | | |

After the serialization of the color information in the mentioned color exchange format C×F has been carried out, for example, by way of the C×F composer software, the corresponding data stream can either be embedded into a data object of any software application of a third party manufacturer or the data stream can be stored in a file. The file is then transported by way of a suitable transport medium (diskette, CD-ROM, FTP, email, Internet) to the location of the recipient. The recipient then loads the C×F file and displays the transferred color data by way of a suitable display software (“C×F viewer”) SE on the screen. The mechanisms for the true color representation mentioned above and, for example, also used in the C×F composer, are again used (for example Apple ColorSync). Alternatively, the user can also print the colors on an output device. The color representations are thereby also adapted for the printing on the output device by use of the color management mechanisms (for example “ColorSync” by Apple Macintosh processors).

A processor supported system with which the process in accordance with the invention for producing a color information data file or for color communication can be carried out typically includes the following components:

a spectrophotometer or other color measuring device suitable for the capturing of colorimetric parameters

a software library which allows the storage or readout of the data and their additional attributes of the color objects or the color in the above described file format (C×F format)

a user software which allows the user to capture any color sample by measuring technology or in text in a device independent or device dependent color space and to assign additional attributes to the so defined color samples (C×F composer)

a suitable data transport medium (for example Internet, or via email, or a conventional data carrier)

a viewer component, which allows the representation (C×F viewer) of the color information on an output device (for example CRT, LCD, beamer or printer . . . )

a color management system, which allows maintaining the color representation on the output devices (screens, printers) consistent (for example Apple ColorSync)

a suitable printer, which allows output of the color samples and their attributes

optionally an appearance modeling system, which allows display of appearance aspects of the color samples.

These components are known per se or described further above so that no further description is required.

The invention also relates to a program for carrying out the disclosed and claimed processes with a computer as well as a storage medium carrying the program.

1. Process for producing an electronic color information file for color communication, which file includes a data set describing the color impression of one or more color samples, whereby the at least one data set is made available in a processor and stored in a preselected data format in the color information file, so that all the information data associated with the color samples and identifying, characterizing or supplementing the color samples, are stored as information data containing data objects in an open, expandable, hierarchically organized object structure in the color information file.

2. Process according to claim 1, wherein each data object is labeled with a characterizing type description (tag) selected from a group of predefined type descriptions (tags), whereby the type description provides details on the structure and content of the data object, and the data type description (tag) of the data object is stored in the color information file in defined relation to the information data of the data object.

3. Process according to claim 1, wherein at least one data object itself includes one or more hierarchically subordinate data objects, whereby each subordinate data object is labeled with a characterizing type description (tag) selected from a predefined group of type descriptions [tags], whereby the type description provides details on the structure and content of the data object, the type description (tag) of the subordinate data object being stored in the color information file in defined relation to the information data of the subordinate data object.

4. Process according to claim 3, wherein a name is associated with the data object of the uppermost level of the hierarchy and/or the data objects respectively subordinate to a data object, which name defines the respective data objects and is stored in the color information file in defined relation to the respective data objects.

5. Process according to claim 3 or 4, wherein an explanatory description is associated with the data object of the uppermost level of the hierarchy and/or the data objects respectively subordinate to a data object, which explanatory description defines the respective data objects and is stored in the color information file in defined relation to the respective data objects.

6. Process according to claim 1, wherein at least one data object includes a subordinate data object which represents a connection pointer (hyperlink) to another data object within or outside the color information file.

7. Process according to claim 1, wherein all data objects are stored in text format in the color information file.

8. Process according to claim 1, wherein at least one data object includes a binary data object as information data, whereby this binary data object is preferably stored in the color information file as symbols in MIME-compatible format.

9. Process according to claim 1, wherein the hierarchically organized object structure of the data objects is built on the basis of a page description language, especially the Extensible Markup Language (XML).

10. Process according to claim 2 or 3, wherein the step of storing of the information data which are associated with the color sample or color samples and identify, characterize or complement the color sample or samples is carried out by arbitrarily selecting from a predefined group of data object types.

11. Process according to claim 10, wherein the predefined group of data object types can be expanded with additional data object types.

12. Process according to claim 10, wherein the predefined group of data object types includes at least data objects for spectral data and calorimetric data (color vectors), and optionally device dependent color data.

13. Process according to claim 12, wherein the predefined group of data object types additionally includes data objects for further information data relevant for the visual impression of the color.

14. Process according to claim 12, wherein the predefined group of data object types additionally includes data objects for ICC profiles, measurement conditions, light source data and device profiles.

15. Process according to claim 12, wherein the predefined group of data object types additionally includes data objects for image data.

16. Process according to claim 12, wherein the predefined group of data object types additionally includes data objects for image data and/or substrate describing data, whereby the image data preferably represent structure information such as surface condition or graininess of the color samples to be communicated.

17. Process according to claim 12, wherein the predefined group of data object types additionally includes data objects for supplementary data representable in text format.

18. Process according to claim 1, wherein any combination of emission, remission and transmission spectra and/or colorimetric data (color vectors) are stored in the color information file.

19. Process according to claim 18, wherein emission spectra of an illumination light source and remission spectra of the color samples are stored in the color information file so that the illumination light source can be taken into consideration by way of a color model for the visual representation of the color samples on a screen.

20. Process according to claim 14, wherein an input profile and preferably several output profiles are assigned to a color sample and stored in the color information file, which input profile is used to recalculate a color sample from a device dependent color space into a device independent color space, and which output profiles are used to recalculate the color location of the color sample from the device independent color space into a selected device dependent color space and to display the color location therein.

21. Process for communicating the information relevant for visual color impression of a color sample set including at least one color sample, whereby the information represented by measured data and/or manually produced value data is stored at a transmitter end in a color information file, the color information file is transferred to a receiver by way of a communication medium and at the receiver end again displayed in visual form, all the information data associated with the color samples and identifying, characterizing or supplementing the color samples, being stored as information data containing data objects in an open, expandable, hierarchically organized object structure in the color information file.

22. Communication process according to claim 21, wherein each data object is labeled with a characterizing type description (tag) selected from a group of predefined type descriptions (tags), whereby the type description provides details on the structure and content of the data object, and the data type description (tag) of the data object is stored in the color information file in defined relation to the information data of the data object.

23. Communication process according to claim 21, wherein at least one data object itself includes one or more hierarchically subordinate data objects, whereby each subordinate data object is labeled with a characterizing type description (tag) selected from a predefined group of type descriptions [tags], whereby the type description provides details on the structure and content of the data object, the type description (tag) of the subordinate data object being stored in the color information file in defined relation to the information data of the subordinate data object.

24. Communication process according to claim 21, wherein a name is associated with the data object of the uppermost level of the hierarchy and/or the data objects respectively subordinate to a data object, which name defines the respective data objects and is stored in the color information file in defined relation to the respective data objects.

25. Communication process according to claim 21, wherein an explanatory description is associated with the data object of the uppermost level of the hierarchy and/or the data objects respectively subordinate to a data object, which explanatory description defines the respective data objects and is stored in the color information file in defined relation to the respective data objects.

26. Communication process according to claim 21, wherein at least one data object includes a subordinate data object which represents a connection pointer (hyperlink) to another data object within or outside the color information file.

27. Communication process according to claim 21, wherein all data objects are stored in text format in the color information file.

28. Communication process according to claim 21, wherein at least one data object includes a binary data object as information data, whereby this binary data object is preferably stored in the color information file as symbols in MIME- compatible format.

29. Communication process according to claim 21, wherein the hierarchically organized object structure of the data objects is built on the basis of a page description language, especially the Extensible Markup Language (XML).

30. Communication process according to claim 22, wherein a predefined amount of data object types is made available, which define the type and structure of typical information data identifying, characterizing or supplementing a color sample, an arbitrary selection of data object types from the predefined amount of data object types or an arbitrary combination of these data object types being used for storage of the information data assigned to the color sample or color samples and identifying, characterizing or supplementing the color samples.

31. Communication process according to claim 30, wherein the predefined group of data object types includes at least data objects for spectral data and colorimetric data (color vectors), and optionally device dependent color data.

32. Communication process according to claim 30, wherein the predefined group of data object types additionally includes data objects for further information data relevant for the visual impression of the color.

33. Communication process according to claim 30, wherein the predefined group of data object types additionally includes data objects for ICC profiles, measurement conditions, light source data and device profiles.

34. Communication process according to claim 30, wherein the predefined group of data object types additionally includes data objects for image data.

35. Communication process according to claim 30, wherein the predefined group of data object types additionally includes data objects for image data and/or substrate describing data, whereby the image data preferably represent structure information such as surface condition or graininess of the color samples to be communicated.

36. Communication process according to claim 30, wherein any combination of emission, remission and transmission spectra and/or colorimetric data (color vectors) are stored in the color information file.

37. Communication process according to claim 36, wherein emission spectra of an illumination light source and remission spectra of the color samples are stored in the color information file, and at the receiving end the illumination light source is taken into consideration by way of a color model and the stored emission spectra for the visual representation of the color samples on a screen.

38. Communication process according to claim 31, characterized in that an input profile and preferably several output profiles are assigned to a color sample and stored in the color information file, that the color sample is recalculated from a device dependent color space into a device independent color space, and that the color location of the color sample is recalculated by way of the output profiles from this device independent color space into a selected device dependent color space and displayed therein.
